(19) United States
(12) Patent Application Publication
(10) Pub. No.: US 2006/0176242 A1
(43) Pub. Date: Aug. 10, 2006

(54) Augmented reality device and method

(75) Inventors: Branislav Jaramaz, Pittsburg, PA (US); Constantinos Nikou, Swissvale, PA (US); Anthony M. Digioia III, Pittsburgh, PA (US)

Correspondence Address: SCHNADER HARRISON SEGAL & LEWIS, LLP, 1600 MARKET STREET, SUITE 3600, PHILADELPHIA, PA, 19103, US

(73) Assignee: BLUE BELT TECHNOLOGIES, INC., PITTSBURGH, PA (US)

(21) Appl. No.: 11/347,086

(22) Filed: Feb. 3, 2006

Related U.S. Application Data
(60) Provisional application No. 60/651,020, filed on Feb. 8, 2005.

(51) Int. Cl. G09G 5/00

(52) U.S. Cl. 345/7

(57) ABSTRACT

An augmented reality device to combine a real world view with an object image. An optical combiner combines the object image with a real world view of the object and conveys the combined image to a user. A tracking system tracks one or more objects. At least a part of the tracking system is at a fixed location with respect to the display. An eyepiece is used to view the combined object and real world images, and fixes the user location with respect to the display and optical combiner location.

This application is based on, and claims priority to, provisional application having Ser. No. 60/651,020, and a filing date of Feb. 8, 2005, entitled Image Overlay Device and Method

### FIELD OF THE INVENTION

The invention relates to augmented reality systems, and is particularly applicable to use in medical procedures.

### BACKGROUND OF THE INVENTION

Augmented reality is a technique that superimposes a computer image over a viewer's direct view of the real world. The position of the viewer's head, objects in the real world environment, and components of the display system are tracked, and their positions are used to transform the image so that it appears to be an integral part of the real world environment. The technique has important applications in the medical field. For example, a three-dimensional image of a bone reconstructed from CT data, can be displayed to a surgeon superimposed on the patient at the exact location of the real bone, regardless of the position of either the surgeon or the patient.

Augmented reality is typically implemented in one of two ways, via video overlay or optical overlay. In video overlay, video images of the real world are enhanced with properly aligned virtual images generated by a computer. In optical overlay, images are optically combined with the real scene using a beamsplitter, or half-silvered mirror. Virtual images displayed on a computer monitor are reflected to the viewer with the proper perspective in order to align the virtual world with the real world. Tracking systems are used to achieve proper alignment, by providing information to the system on the location of objects such as surgical tools, ultrasound probes and a patient's anatomy with respect to the user's eyes. Tracking systems typically include a controller, sensors and emitters or reflectors.

In optical overlay the partially reflective mirror is fixed relative to the display. A calibration process defines the location of the projected display area relative to a tracker mounted on the display. The system uses the tracked position of the viewpoint, positions of the tools, and position of the display to calculate how the display must draw the images so that their reflections line up properly with the user's view of the tools.

It is possible to make a head mounted display (HMD) that uses optical overlay, by miniaturizing the mirror and computer display. The necessity to track the user's viewpoint in this case is unnecessary because the device is mounted to the head, and the device's calibration process takes this into account. The mirrors are attached to the display device and their spatial relationship is defined in calibration. The tools and display device are tracked by a tracking system. Due to the closeness of the display to the eye, very small errors/motions in the position (or calculated position) of the display on the head translate to large errors in the user workspace, and difficulty in calibration. High display resolutions are also much more difficult to realize for an HMD. HMDs are also cumbersome to the user. These are significant disincentives to using HMDs.

Video overlay HMDs have two video cameras, one mounted near each of the user's eyes. The user views small displays that show the images captured by the video cameras combined with any virtual images. The cameras can also serve as a tracking system sensor, so the relative position of the viewpoint and the projected display area are known from calibration So only tool tracking is necessary. Calibration problems and a cumbersome nature also plague HMD video overlay systems.

A device commonly referred to as a “sonic flashlight” (SF) is an augmented reality device that merges a captured image with a direct view of an object independent of the viewer location. The SF does not use tracking, and it does not rely on knowing the user viewpoint. It accomplishes this by physically aligning the image projection with the data it should be collecting. This accomplishment actually limits the practical use of the system, in that the user has to peer through the mirror to the area where the image would be projected. Mounting the mirror to allow this may result in a package that is not ergonomically feasible for the procedure for which it is being used. Also, in order to display 3D images, SF would need to use a 3D display, which results in much higher technologic requirements, which are not currently practical. Furthermore, if an SF were to be used to display anything other than the real time tomographic image (e.g. unimaged tool trajectories), then tracking would have to be used to monitor the tool and display positions.

Also known in the art is an integrated videography (IV) having an autostereoscopic display that can be viewed from any angle. Images can be displayed in 3D, eliminating the need for viewpoint tracking because the data is not shown as a 2D perspective view. The device has been incorporated into the augmented reality concept for a surgical guidance system. A tracking system is used to monitor the tools, which is physically separated from the display. Calibration and accuracy can be problematic in such configurations. This technique involves the use of highly customized and expensive hardware, and is also very computationally expensive.

The design of augmented reality systems used for surgical procedures requires sensitive calibration and tracking accuracy. Devices tend to be very cumbersome for medical use and expensive, limiting there usefulness or affordability Accordingly, there is a need for an augmented reality system that can be easily calibrated, is accurate enough for surgical procedures and is easily used in a surgical setting.

### SUMMARY OF THE INVENTION

The present invention provides an augmented reality device to combine a real world view with information, such as images, of one or more objects. For example, a real world view of a patient's anatomy may be combined with an image of a bone within that area of the anatomy. The object information, which is created for example by ultrasound or a CAT scan, is presented on a display. An optical combiner combines the object information with a real world view of the object and conveys the combined image to a user. A tracking system tracks the location of one or more objects, such as surgical tools, ultrasound probe or body part to assure proper alignment of the real world view with object information. At least a part of the tracking system is at a fixed location with respect to the display. A non-head mounted eyepiece is provided at which the user can view the combined object and real world views. The eyepiece fixes the user location with respect to the display location and the optical combiner location so that the user's position need not be tracked directly.

### DESCRIPTION OF THE DRAWINGS

The invention is best understood from the following detailed description when read with the accompanying drawings.

FIG. 1 depicts an augmented reality overlay device according to an illustrative embodiment of the invention.

FIG. 2 depicts an augmented reality device according to a further illustrative embodiment of the invention.

FIGS. 3A-B depict augmented reality devices using an infrared camera according to an illustrative embodiment of the invention.

FIG. 4 depicts an augmented reality device showing tracking components according to an illustrative embodiment of the invention.

FIGS. 5A-C depict a stereoscopic image overlay device according to illustrative embodiments of the invention.

FIG. 6 depicts an augmented reality device with remote access according to an illustrative embodiment of the invention.

FIGS. 7A-C depict use of mechanical arms according to illustrative embodiments of the invention.

### DETAILED DESCRIPTION OF THE INVENTION

Advantageously, embodiments of the invention may provide an augmented reality device that is less sensitive to calibration and tracking accuracy errors, less cumbersome for medical use, less expensive and easier to incorporate tracking into the display package than conventional image overlay devices. An eyepiece is fixed to the device relative to the display so that the location of the projected display and the user's viewpoint are known to the system after calibration, and only the tools, such as surgical instruments, need to be tracked. The tool (and other object) positions are known through use of a tracking system. Unlike video-based augmented reality systems, which are commonly implemented in HMD systems, the actual view of the patient, rather than an augmented video view, is provided.

The present invention, unlike the SF has substantially unrestricted viewing positions relative to tools (provided the tracking system used does not require line-of-sight to the tools), 3D visualization, and superior ergonomics.

The disclosed augmented reality device in its basic form includes a display to present information that describes one or more objects in an environment simultaneously. The objects may be, for example, a part of a patient's anatomy, a medical tool such as an ultrasound probe, or a surgical tool. The information describing the objects can be images, graphical representations or other forms of information that will be described in more detail below. Graphical representations can, for example, be of the shape, position and/or the trajectory of one or more objects.

An optical combiner combines the displayed information with a real world view of the objects, and conveys this augmented image to a user. A tracking system is used to align the information with the real world view. At least a portion of the tracking system is at a fixed location with respect to the display.

If the camera (sensor) portion of the tracking system is attached to a box housing the display, i.e. if they are in a single unit or display unit, it would not require the box to be tracked, and would create a more ergonomically desirable device. Preferably the main reference portion of the tracking system (herein referred to as the “base reference object”) is attached to the single unit. The base reference object may be described further as follows: tracking systems typically report the positions of one or more objects, or markers relative to a base reference coordinate system. This base coordinate system is defined relative to a base reference object. The base reference object in an optical tracking system, for example, is one camera or a collection of cameras; (the markers are visualized by the camera(s), and the tracking system computes the location of the markers relative to the camera(s). The base reference object in an electromagnetic tracking system can be a magnetic field generator that invokes specific currents in each of the markers, allowing for position determination.

It can be advantageous to fix the distance between the tracking system's base reference object and the display, for example by providing them in a single display unit. This configuration is advantageous for two reasons. First, it is ergonomically advantageous because the system can be configured to place the tracking system's effective range directly in the range of the display. There are no necessary considerations by the user for external placement of the reference base. For example, if using optical tracking, and the cameras are not mounted to the display unit, then the user must determine the camera system placement so that both the display and the tools to be tracked can all be seen with the camera system. If the camera system is mounted to the display device, and aimed at the workspace, then the only the tools must be visible, because the physical connection dictates a set location of the reference base to the display unit.

Second, there is an accuracy advantage in physically attaching the base reference to the display unit. Any error in tracking that would exist in external tracking of the display unit is eliminated. The location of the display is fixed, and determined through calibration, rather than determined by the tracking system, which has inherent errors. It is noted that reference to “attaching” or “fixing” includes adjustably attaching or fixing.

Finally, the basic augmented reality device includes a non-head mounted eyepiece at which the user can view the augmented image and which fixes the user location with respect to the display location and the optical combiner location.

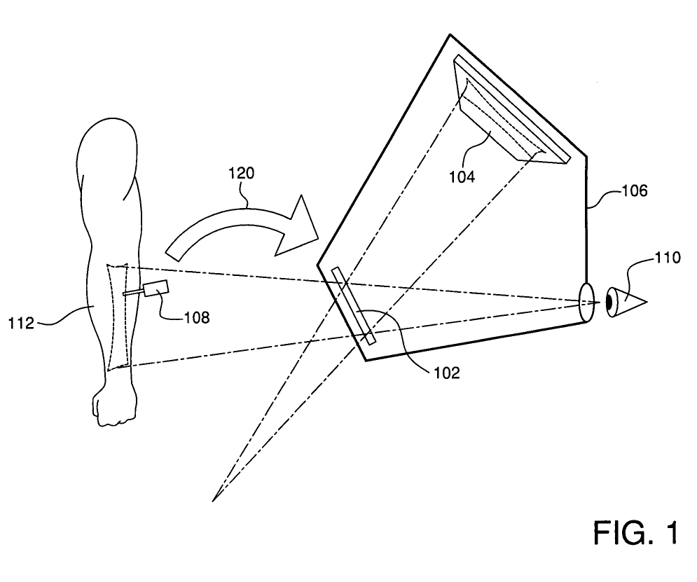

FIG. 1 depicts an augmented reality device having a partially transmissive mirror 102 and a display 104, both housed in a box 106. A viewer 110 views a patient's arm 112 directly. The display 104 displays an image of the bone from within the arm 112. This image is reflected by mirror 102 to viewer 110. Simultaneously, viewer 110 sees arm 112. This causes the image of the bone to be overlaid on the image of the arm 112, providing viewer 110 with an x-ray-type view of the arm. A tracking marker 108 is placed on arm 112. Arrow 120 represents the tracker reporting its position back to the box so the display image can be aligned to provide viewer 110 with a properly superimposed image of the bone on arm 112.

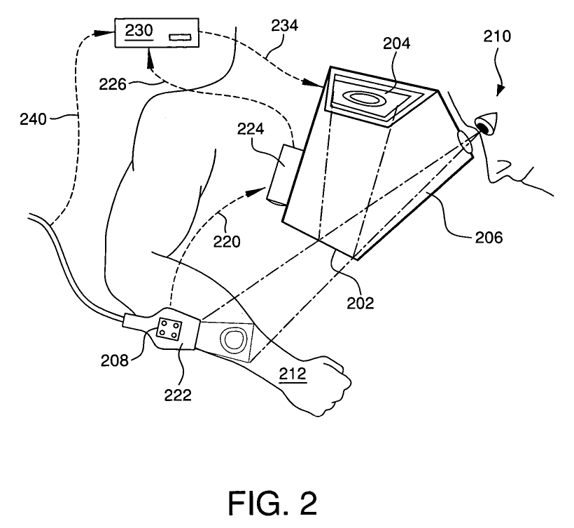

FIG. 2 shows an augmented reality device having a display 204 and a partially transmissive mirror 202 in a box 206. The device is shown used with an ultrasound probe 222. Display 204 provides a rendering of the ultra sound data, for example as a 3-D rotation. (The ultrasound data may be rotated so the ultrasound imaging plane is as it would appear in real life.) Mirror 202 reflects the image from display 204 to viewer 210. At the same time, viewer 210 sees the patient's arm 212 directly. As a result, the ultrasound image is superimposed on the patient's arm 212. Ultrasound probe 222 has a tracking marker 208 on it. Arrow 220 represents tracking information going from tracking marker 208 to tracking sensors and tracking control box 224. Arrow 226 represents the information being gathered from the sensors and control box 224 being sent to a processor 230. Arrow 240 represents the information from the ultrasound probe 222 being sent to processor 230. It is noted that one or more components may exist between probe 222 and processor 230 to process the ultrasound information for suitable input to processor 230. Processor 230 combines information from marker 208 and ultrasound probe 222. Arrow 234 represents the properly aligned data being sent from processor 230 to display 204.

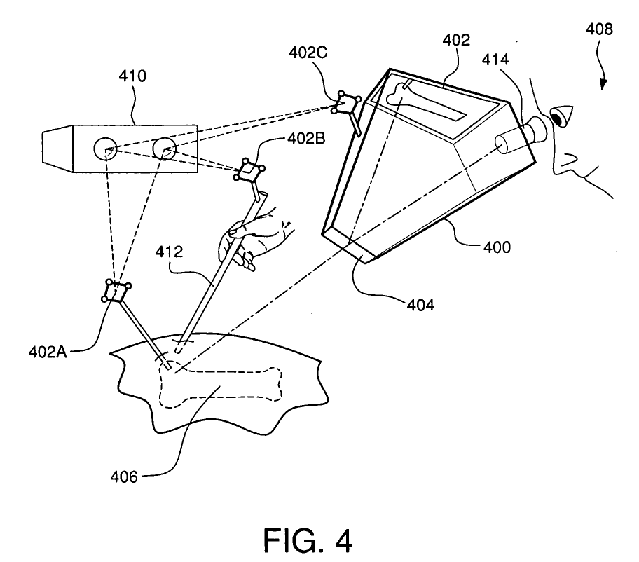

FIG. 4 depicts an augmented reality device according to a further embodiment of the invention. User 408 views an augmented image through eyepiece 414. The augmented image includes a real time view of bone 406 and surgical tool 412. The bone is marked by a tracking marker 420A. Surgical tool 412 is tracked using tracking marker 402B. Tracking marker 402C is positioned on box 400, which has a display 402 and optical combiner 404 fixed thereto. Tracking markers 402A-C provide information to controller 410 on the location of tool 412 and bone 406 with respect to the display located in box 400. Controller 410 can then provide information to input to a processing unit (not shown) to align real time and stored images on the display.

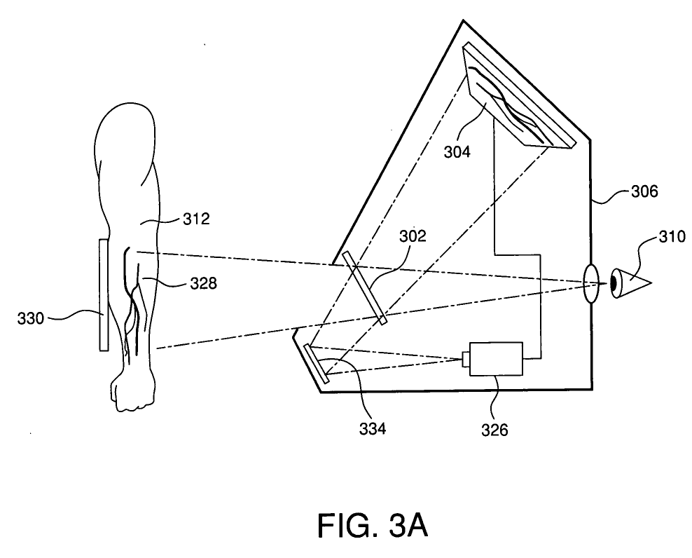

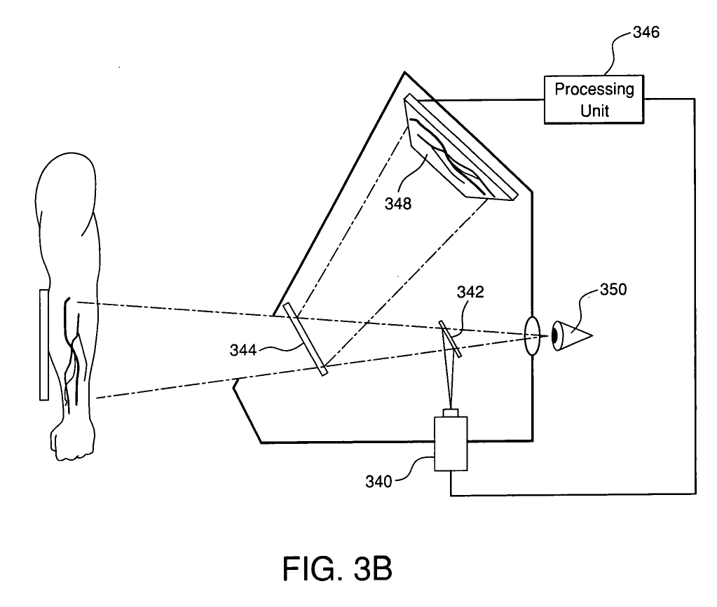

FIG. 3A depicts an augmented reality system using an infrared camera 326 to view the vascular system 328 of a patient. As in FIGS. 1 and 2, a box 306 contains a partially transmissive mirror 302 and a display 304 to reflect an image to viewer 310. Viewer 310 also views the patient's arm 312 directly. An infrared source 330 is positioned behind the patient's arm 312 with respect to box 306. An infrared image of vascular system 328 is reflected first by mirror 302 (which is 100%, or close to 100%, reflective only of infrared wavelengths, and partially reflective for visible wavelengths), and then by a second mirror 334 to camera 326. Second mirror 334 reflects infrared only and passes visible light. Camera 326 has an imaging sensor to sense the infrared image of vascular system 328. It is noted that camera 326 can be positioned so mirror 334 is not necessary for camera 326 to sense the infrared image of vascular system 328. As used herein, the phrase “the infrared camera is positioned to sense an infrared image” includes the camera positioned to directly receive the infrared image and indirectly, such as by use of one or more mirrors or other optical components. Similarly, the phrase, “positioned to convey the infrared image to a processing unit” includes configurations with and without one or more mirrors or other optical components. Inclusion of mirror 334 may be beneficial to provide a compact design of the device unit. The sensed infrared image is fed to a processor that creates an image on display 304 in the visual light spectrum. This image is reflected by mirror 302 to viewer 310. Viewer 310 then sees the vascular system 328 superimposed on the patient's arm 312.

FIG. 3B depicts another illustrative embodiment of an augmented reality system using an infrared camera. In this embodiment infrared camera 340 and second optical combiner 342 are aligned so infrared camera 340 can sense an infrared image conveyed through first optical combiner 344 and reflected by second optical combiner 342, and can transmit the infrared image to a processing unit 346 to be converted to a visible light image which can be conveyed to display 348. In this illustrative embodiment, camera 340 sees the same view as user 350, for example at the same focal distance and with the same field of view. This can be accomplished by placing camera 340 in the appropriate position with respect to second optical combiner 342, or using optics between camera 340 and second optical combiner 342 to accomplish this. If an infrared image of the real scene is the only required information for the particular procedure, tracking may not be needed. For example, if the imager, i.e. the camera picking up the infrared image, is attached to the display unit, explicit tracking is not needed to overlay this infrared information onto the real world view, provided that the system is calibrated. (The infrared imager location is known implicitly because the imager is fixed to the display unit.) Another example is if an MRI machine or other imaging device is at a fixed location with respect to the display, the imaging source would not have to be tracked because it is at a fixed distance with respect to the display. A calibration process would have to be performed to ensure that the infrared camera is seeing the same thing that the user would see in a certain position. Alignment can be done electronically or manually. In one embodiment, the camera is first manually roughly aligned, then the calibration parameters that define how the image from the camera is warped in the display are tweaked by the user while viewing a calibration grid. When the overlaid and real images of the grid are aligned to the user, the calibration is complete.

Although the embodiments described above include infrared images, other nonvisible images, or images from subsets of the visible spectrum can be used and converted to visible light in the same manner as described above.

The term “eyepiece” is used herein in a broad sense and includes a device that would fix a user's viewpoint with respect to the display and optical combiner. An eyepiece may contain vision aiding tools and positioning devices. A vision aiding tool may provide magnification or vision correction, for example. A positioning device may merely be a component against which a user would position their forehead or chin to fix their distance from the display. Such a design may be advantageous because it could accommodate users wearing eyeglasses. Although the singular “eyepiece” is used here, an eyepiece may contain more than one viewing component.

The eye piece may be rigidly fixed with respect to the display location, or it may be adjustably fixed. If adjustably fixed, it can allow for manual adjustments or electronic adjustments. In a particular embodiment of the invention, a sensor, such as a linear encoder, is used to provide information to the system regarding the adjusted eye piece position, so the displayed information can be adjusted to compensate for the adjusted eyepiece location. The eye piece may include a first eye piece viewing component and a second eye piece viewing component associated with each of a user's eye. The system can be configured so that each eye piece viewing component locates a different view point or prospective with respect to the display location and the optical combiner location. This can be used to achieve an affect of depth perception.

Preferably the display, the optical combiner, at least a portion of the tracking system and the eyepiece are housed in a single unit (referred to sometimes herein as a “box”, although each component need not be within an enclosed space). This provides fixed distances and positioning of the user with respect to the display and optical combiner, thereby eliminating a need to track the user's position and orientation. This can also simplify calibration and provide a less cumbersome device.

Numerous types of information describing the objects may be displayed. For example, a rendering of a 3D surface of an object may be superimposed on the object. Further examples include surgical plans, object trajectories, such as that of a medical tool.

Real-time input to the device may be represented in various ways. For example, if the device is following a surgical tool with a targeted location, the color of the tool or its trajectory can be shown to change, thereby indicating the distance to the targeted location. Displayed information may also be a graphical representation of real-time data. The displayed information may either be real-time information, such as may be obtained by an ultrasound probe, or stored information such as from an x-ray or CAT scan.

In an exemplary embodiment of the invention, the optical combiner is a partially reflective mirror. A partially reflective mirror is any surface that is partially transmissive and partially reflective. The transmission rates are dependent, at least in part on lighting conditions. Readily available 40/60 glass can be used, for example, meaning the glass provides 40% transmission and 60% reflectivity. An operating room environment typically has very bright lights, in which case a higher portion of reflectivity is desirable, such as 10/90. The optical combiner need not be glass, but can be a synthetic material, provided it can transmit and reflect the desired amount of light. The optical combiner may include treatment to absorb, transmit and/or reflect different wavelengths of light differently.

The information presented by the display may be an image created, for example, by an ultrasound, CAT scan, MRI, PET, cine-CT or x-ray device. The imaging device may be included as an element of the invention. Other types of information include, but are not limited to, surgical plans, information on the proximity of a medical tool to a targeted point, and various other information. The information may be stored and used at a later time, or may be a real-time image. In an exemplary embodiment of the invention, the image is a 3D model rendering created from a series of 2D images. Information obtained from tracking the real-world object is used to align the 3D image with the real world view.

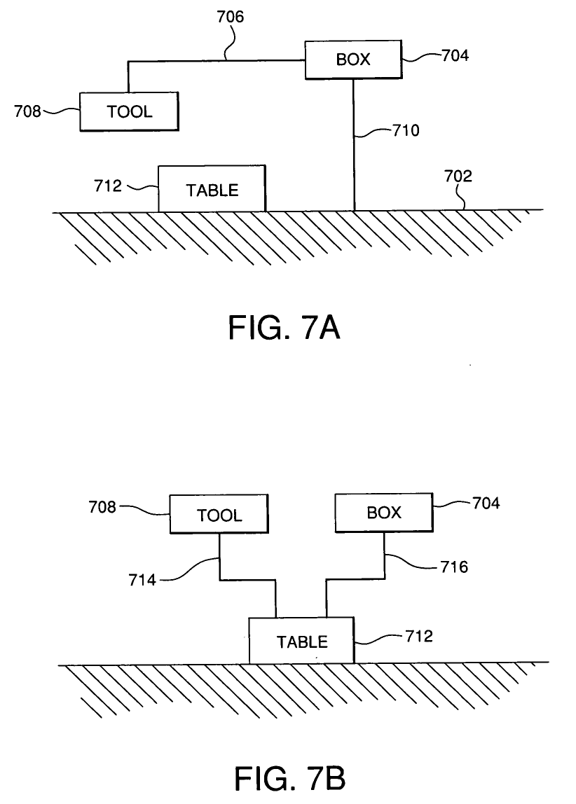

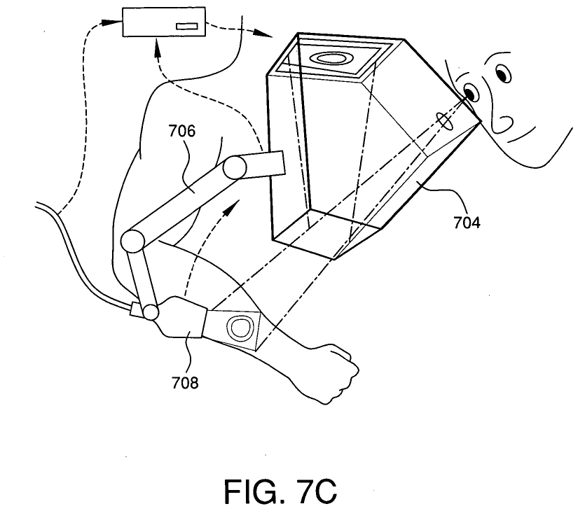

The device may be hand held or mounted on a stationary or moveable support. In a preferred embodiment of the invention, the device is mounted on a support, such as a mechanical or electromechanical or arm that is adjustable in at least one linear direction, i.e., the X, Y or Z direction. More preferably, the support provides both linear and angular adjustability. In an exemplary embodiment of the invention, the support mechanism is a boom-type structure. The support may be attached to any stationary object. This may include for example, a wall, floor, ceiling or operating table. A movable support can have sensors for tracking. Illustrative support systems are shown in FIGS. 7A-C.

FIG. 7A depicts a support 710 extending from the floor 702 to a box 704 to which a display is fixed. A mechanical 706 arm extends from box 704 to a tool 708. Encoders may be used to measure movement of the mechanical arm to provide information regarding the location of the tool with respect to the display. FIG. 7C is a more detailed illustration of a tool, arm and box section of the embodiment depicted in FIG. 7A using the exemplary system of FIG. 2.

FIG. 7B is a further illustrative embodiment of the invention in which a tool 708 is connected to a stationary operating table 712 by a mechanical arm 714 and operating table 712 in turn is connected to a box 704, to which the display is fixed, by a second mechanical arm 716. In this way the tool's position with respect to box 704 is known. More generally, the mechanical arms are each connected to points that are stationary with respect to one another. This would include the arms being attached to the same point. Tracking can be accomplished by encoders on the mechanical arms. Portions of the tracking system disposed on one or more mechanical arms may be integral with the arm or attached as a separate component.

The key in the embodiments depicted in FIGS. 7A and 7B is that the position of the tool with respect to the display is known. Thus, one end of a mechanical arm is attached to the display or something at a fixed distance to the display. The mechanical arms may be entirely mechanical or adjustable via an electronic system, or a combination of the two.

Numerous types of tracking systems may be used. Any system that can effectively locate a tracked item and is compatible with the system or procedure for which it is used, can serve as a tracking device. Examples of tracking devices include optical, mechanical, magnetic, electromagnetic, acoustic or a combination thereof. Systems may be active, passive and inertial, or a combination thereof. For example, a tracking system may include a marker that either reflects or emits signals.

Numerous display types are within the scope of the invention. In an exemplary embodiment an autostereoscopic liquid crystal display is used, such as a Sharp LL-151D or DTL 2018XLC. To properly orient images and views on a display it may be necessary to reverse, flip, rotate, translate and/or scale the images and views. This can be accomplished through optics and/or software manipulation.

FIG. 2 described above depicts a mono image display system with ultrasound and optical tracking according to an illustrative embodiment of the invention. In a further embodiment of the invention, the combined image is displayed stereoscopically. To achieve 3D depth perception without a holographic or integrated videography display, a technique called stereoscopy can be used. This method presents two images (one to each eye) that represent the two slightly different views that result from the disparity in eye position when viewing a scene. Following is a list of illustrative techniques to implement stereoscopy:
1. using two displays to display the disparate images to each eye;
2. using one display showing the disparate images simultaneously, and mirrors/prisms to redirect the appropriate images to each eye;
3. using one display and temporally interleaving the disparate images, along with using a “shuttering” method to only allow the appropriate image to reach the appropriate eye at a particular time;
4. using an autostereoscopic display, which uses special optics to display the appropriate images to each eye for a set user viewing position (or set of user viewing positions).

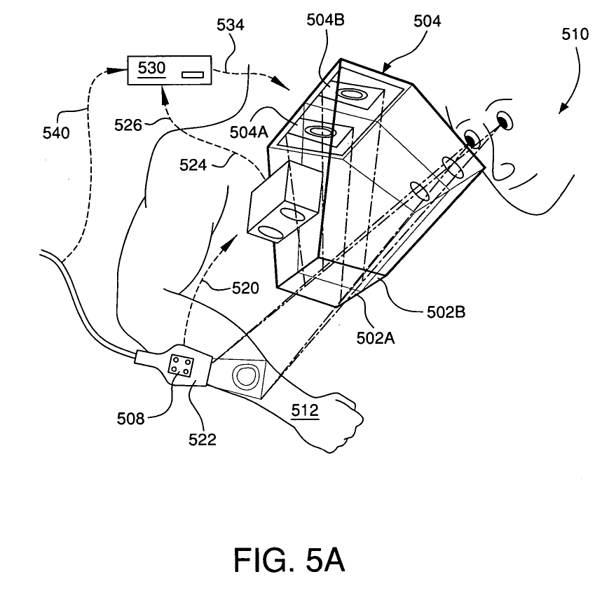

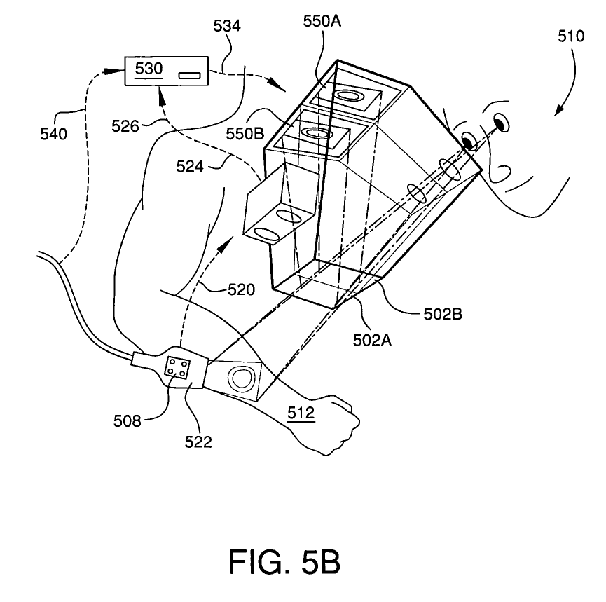

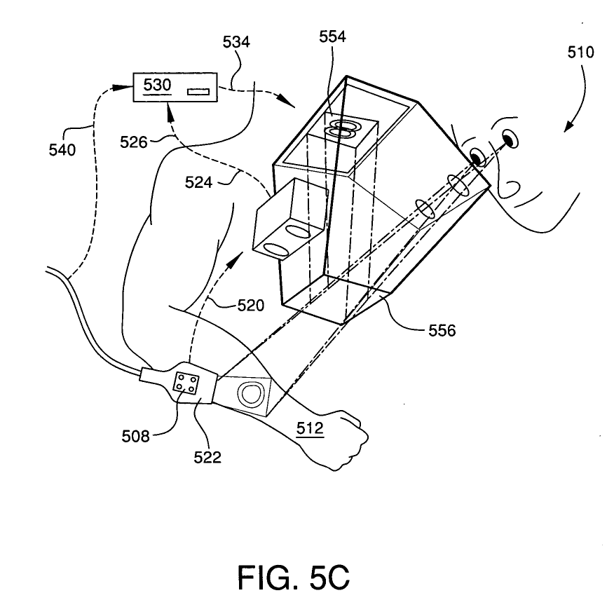

A preferred embodiment of the invention utilizes an autostereoscopic display, and uses the eyepieces to locate the user at the required user viewer position. FIGS. 5A-C depict stereoscopic systems according to illustrative embodiments of the invention. FIG. 5A depicts a stereoscopic image overlay system using a single display 504 with two images 504A, 504B. There are two optical combiners 502A, 502B, which redirect each half of the image to the appropriate eye. The device is shown used with an ultrasound probe 522. Display 504 provides two images of the ultrasound data each from a different perspective. Display portion 504A shows one perspective view and display portion 504B shows the other perspective view. Optical combiner 502A reflects the images from display 504 to one eye of viewer 510, and optical combiner 502B reflects the images from display 504B to the other eye of viewer 510. At the same time, viewer 510 sees directly two different perspective views of the patient's arm 512, each view seen by a different eye. As a result, the ultrasound image is superimposed on the patient's arm 512, and the augmented image is displayed stereoscopically to viewer 510.

Tracking is performed in a manner similar to that of a mono-image display system. Ultrasound probe 522 has a tracking marker 508 on it. Arrow 520 represents tracking information going from tracking marker 508 to tracking sensors and tracking base reference object 524. Arrow 526 represents the information being gathered from the sensors and base reference 524 being sent to a processor 530. Arrow 540 represents the information from the ultrasound unit 522 being sent to processor 530. Processor 530 combines information from marker 508 and ultrasound probe 522. Arrow 534 represents the properly aligned data being sent from processor 530 to display portions 504A, 504B.

FIG. 5B depicts a stereoscopic system using two separate displays 550A, 550B. Use of two displays gives the flexibility of greater range in display placement. Again, two mirrors 502A, 502B are required.

FIG. 5C shows an autostereoscopic image overlay system. There are two blended/interlaced images on a single display 554. The optics in display 554 separate the left and right images to the corresponding eyes. Only one optical combiner 556 is shown, however, there could be two if necessary.

As shown in FIGS. 5A-C, stereoscopic systems can have many different configurations. A single display can be partitioned to accommodate two different images. Two displays can be used, each having a different image. A single display can also have interlaced images, such as alternating columns of pixels wherein odd columns would correspond to a first image that would be conveyed to a user's first eye, and even columns would correspond to a second image that would be conveyed to the user's second eye. Such a configuration would require special polarization or optics to ensure that the proper images reach each eye.

In a further embodiment of the invention, an augmented image can be created using a first and second set of displayed information and a real world view. The first set of displayed information is seen through a first eye piece viewing component on a first display. The second set of displayed information is seen on a second display through the second eye piece viewing component. The two sets of information are displayed in succession.

For some applications it is preferable to have the display in wireless communication with respect to the processing unit. It may also be desirable to have the tracking system wirelessly in communication with respect to the processing unit, or both.

In a further illustrative embodiment of the invention, you can have the image overlay highlight or outline objects in a field. This can be accomplished with appropriate mirrors and filters. For example, certain wavelengths of invisible light could be transmitted/reflected (such as “near-infrared”, which is about 800 nm) and certain wavelengths could be restricted (such as ultraviolet and far-infrared). In embodiments similar to the infrared examples, you can position a camera to have the same view as the eyepiece, then take the image from that camera, process the image, then show that processed image on the display. In the infrared example, a filter is used to image only the infrared light in the scene, then the infrared image is processed, changed to a visible light image via the display, thereby augmenting the true scene with additional infrared information.

In yet another embodiment of the invention a plurality of cameras is used to process the visible/invisible light images, and is also used as part of the tracking system. The cameras can sense a tracking signal such as an infrared LED emitting from the trackers. Therefore, the cameras are simultaneously used for stereo visualization of a vascular infrared image and for tracking of infrared LEDs. A video based tracking system could be implemented in this manner if the system is using visible light.

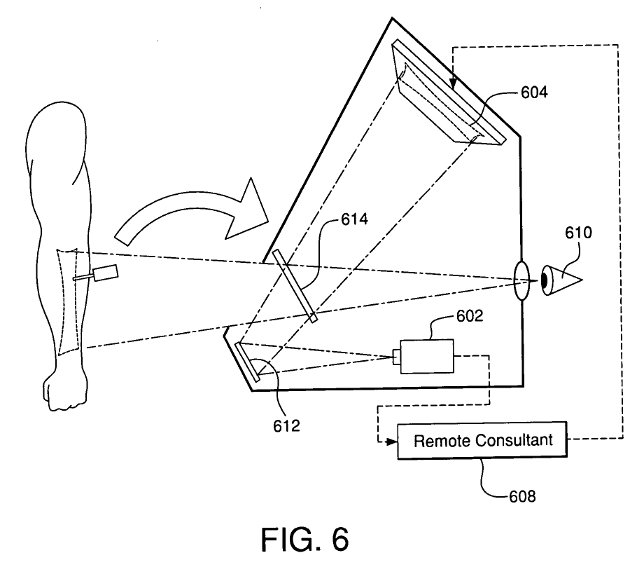

FIG. 6 depicts a further embodiment of the invention in which a link between a camera 602 and a display 604 goes through a remote user 608 who can get the same view as the user 610 at the device location. The system can be configured so the remote user can augment the image, for example by overlaying sketches on the real view. This can be beneficial for uses such as telemedicine, teaching or mentoring. FIG. 6 shows two optical combiners 612 and 614. Optical combiner 614 provides the view directed to user 610 and optical combiner 612 provides the view seen by camera 602, and hence remote user 608.

Information from U.S. Pat. No. 6,753,828 is incorporated by reference as the disclosed information relates to use in the present invention.

The invention, as described above may be embodied in a variety of ways, for example, a system, method, device, etc.

While the invention has been described by illustrative embodiments, additional advantages and modifications will occur to those skilled in the art. Therefore, the invention in its broader aspects is not limited to specific details shown and described herein. Modifications, for example, to the type of tracking system, method or device used to create object images and precise layout of device components may be made without departing from the spirit and scope of the invention. Accordingly, it is intended that the invention not be limited to the specific illustrative embodiments, but be interpreted within the full spirit and scope of the detailed description and the appended claims and their equivalents.

1. An augmented reality device comprising:
a display to present information that describes one or more objects simultaneously;
an optical combiner to combine the displayed information with a real world view of the one or more objects and convey an augmented image to a user;
a tracking system to track one or more of the one or more objects, wherein at least a portion of the tracking system is at a fixed location with respect to the display; and
a non-head mounted eyepiece at which the user can view the augmented image and which fixes the user location with respect to the display location and the optical combiner location.

2. The device of claim 1 wherein the display, the optical combiner, at least a portion of the tracking system and the eyepiece are located in a display unit.

3. The device of claim 2 wherein any one or more of the components that are fixed to the display unit are adjustably fixed.

4. The device of claim 2 wherein a base reference object of the tracking system is fixed to the display unit.

5. The device of claim 1 wherein the eyepiece comprises a first eyepiece viewing component and a second eyepiece viewing component and each eyepiece viewing component locates a different viewpoint with respect to the display location and the optical combiner location.

6. The device of claim 5 further comprising a second display and a second optical combiner wherein the first display and the first optical combiner create a first augmented image to be viewed at the first eyepiece viewing component and the second display and the second optical combiner create a second augmented image to be viewed at the second eyepiece viewing component.

7. The device of claim 5 wherein the display is partitioned spatially into a first display area and a second display area and wherein the first display area and the first optical combiner create a first augmented image to be viewed at the first eyepiece viewing component and the second display area and the second optical combiner create a second augmented image to be viewed at the second eyepiece viewing component.

8. The device of claim 5 wherein the display presents a first set of displayed information to the first eyepiece viewing component and a second set of displayed information to the second eyepiece viewing component in succession, thereby creating an augmented image comprising the first and second sets of displayed information and the real world view.

9. The device of claim 5 wherein the display is an autostereoscopic display.

10. The device of claim 1 configured to display information in the form of a graphical representation of data describing the one or more of the objects.

11. The device of claim 10 in which the graphical representation includes one or more of the shape, position, and trajectory of one or more of the objects.

12. The device of claim 1 configured to display information in the form of real-time data.

13. The device of claim 1 configured to display information comprising at least part of a surgical plan.

14. The device of claim 1 further comprising an ultrasound imaging device functionally connected to the augmented reality device to provide information to the display.

15. The device of claim 1 further comprising an information storage device functionally connected to the augmented reality device to store information to be displayed on the display.

16. The device of claim 1 further comprising an electronic eyepiece adjustment component.

17. The device of claim 16 further comprising a sensor wherein the eyepiece adjustment component adjusts the position of the eyepiece based on information received from a sensor.

18. The device of claim 1 further comprising a support on which the device is mounted.

19. The device of claim 1 further comprising a processing unit configured to process information necessary to combine the displayed information with the real world view.

20. The device of claim 19 wherein the processing unit is a portable computer.

21. The device of claim 19 wherein the display is wireless with respect to the processing unit.

22. The device of claim 19 wherein the tracking system is wireless with respect to the processing unit.

23. The device of claim 1 wherein at least a portion of the tracking system is disposed on one or more arms wherein the arm(s) are attached to the object or a point fixed with respect to the display, or both.

24. The device of claim 1 wherein the optical combiner is a partially-silvered mirror.

25. The device of claim 1 wherein the optical combiner reflects, transmits, and/or absorbs selected wavelengths of electromagnetic radiation.

26. The device of claim 1 further comprising a remote display for displaying the augmented image at a remote location.

27. The device of claim 1 further comprising a remote input device to enable a user at the remote display further augment the augmented image.

28. The device of claim 1 further comprising an infrared camera wherein the infrared camera is positioned to sense an infrared image and convey the infrared image to a processing unit to be converted to a visible light image which is conveyed to the display.

29. The device of claim 1 further comprising an imaging device for capturing at least some of the information that describes at least one of the one or more objects.

30. The device of claim 1 wherein the tracking system comprises one or more markers and one or more receivers and the markers communicate with the receivers wirelessly.

31. The device of claim 1 wherein the eyepiece includes one or more magnification tools.

32. An image overlay method comprising:
presenting information on a display that describes one or more objects simultaneously;
combining the displayed information with a real world view of the one or more objects to create an augmented image using an optical combiner;
tracking one or more of the objects using a tracking system wherein at least a portion of the tracking system is at a fixed location with respect to the display;
fixing the location of a user with respect to the display location and the optical combiner location using a non-head-mounted eyepiece; and
conveying the augmented image to a user.

33. The method of claim 32 further comprising locating the display, the optical combiner, at least a portion of the tracking system and the eyepiece all in a display unit.

34. The method of claim 32 comprising displaying different information to each eye of a user to achieve stereo vision.

35. The method of claim 32 wherein the augmented image is transmitted to a first eye of the user, the method further comprising:
presenting information on a second display; and
transmitting the information from the second display to a second optical combiner to be transmitted to a second eye of the user.

36. The method of claim 35 comprising;
using a spatially partitioned display having a first display area and a second display area to display information;
presenting information to a first optical combiner from the first display area to create a first augmented image to be transmitted to first eye of the user; and
presenting information to a second optical combiner from the second display area to create a second augmented image to be transmitted to a second eye of the user.

37. The method of claim 35 comprising:
displaying the different information to each eye in succession, thereby creating an augmented image comprising the first and second sets of displayed information with the real world view.

38. The method of claim 32 comprising using an autostereoscopic display to present the information describing the one or more objects.

39. The method of claim 32 comprising displaying the information in the form of a graphical representation of data describing one or more objects.

40. The method of claim 32 comprising displaying at least some of the information on the display in a 3-D rendering of the surface of at least a part of one or more of the objects in the real world view.

41. The method of claim 32 wherein at least some of the information displayed on the display is at least a part of a surgical plan.

42. The method of claim 32 comprising displaying one or more of a shape, position, trajectory of at least one of the objects in the real world view.

43. The method of claim 32 comprising conveying the information by varying color to represent real-time input to the device.

44. The method of claim 32 wherein at least some of the displayed information represents real-time data.

45. The method of claim 32 comprising using an ultrasound device to obtain at least some of the information that describes the one or more objects.

46. The method of claim 32 wherein one of the objects is an ultrasound probe, the method further comprising:
tracking the ultrasound probe to locate an ultrasound image with respect to at least one other of the one or more objects being tracked and the real world view.

47. The method of claim 32 further comprising adjustably fixing the eyepiece with respect to the display location.

48. The method of claim 47 further comprising adjusting the eyepiece using an electronic eyepiece adjustment component.

49. The method of claim 48 wherein the eyepiece adjustment component adjusts the position of the eyepiece based on information received from a sensor.

50. The method of claim 32 further comprising tracking at least one of the one or more objects by locating at least a portion of the tracking system on one or more arms.

51. The method of claim 32 wherein the displayed information is combined with the real world view of the one or more objects to create an augmented image using a processing unit to combine the information and the real world view and the processing unit communicates with the display wirelessly.

52. The method of claim 32 wherein the tracking system is wireless with respect to the processing unit.

53. The method of claim 32 wherein the optical combiner is a half-silvered mirror.

54. The method of claim 32 wherein the displayed information and the real world view of the one or more objects is combined with an optical combiner that reflects, transmits, and/or absorbs selected wavelengths of electromagnetic radiation.

55. The method of claim 32 further comprising displaying the augmented image at a remote location.

56. The method of claim 55 further comprising inputting further augmentation to the augmented image by a user at the remote location.

57. The method of claim 32 further comprising:
positioning an infrared camera to sense an infrared image;
conveying the infrared image to a processing unit;
converting the infrared image by the processing unit to a visible light image; and
conveying the visible light image to the display.

58. The method of claim 32 wherein at least some of the information that describes the one or more objects is captured with an ultrasound device.

59. The method of claim 32 wherein the tracking system comprises one or more markers and one or more receivers and the markers communicate with the receivers wirelessly.

60. The method of claim 32 further comprising:
magnifying the user's view.

61. A medical procedure comprising the augmented reality method of claim 32.

62. A medical procedure utilizing the device of claim 1.
